(19) United States
(12) Patent Application Publication
(10) Pub. No.: US 2011/0240620 A1
(43) Pub. Date: Oct. 6, 2011

(54) WELDING SYSTEM AND METHOD UTILIZING INTERNAL ETHERNET COMMUNICATIONS

(75) Inventors: Brian L. Ott, Sherwod, WI (US); Quinn W. Schartner, Kaukauna, WI (US); Jeremy D. Overesch, Neenah, WI (US); Andrew D. Nelson, Appleton, WI (US)

(73) Assignee: Illinois Tool Works Inc., Glenview, IL (US)

(21) Appl. No.: 13/034,252

(22) Filed: Feb. 24, 2011

Related U.S. Application Data
(60) Provisional application No. 61/320,977, filed on Apr. 5, 2010.

(51) Int. Cl. B23K 9/10

(52) U.S. Cl. 219/130.5

(57) ABSTRACT

A welding system and method utilizing internal Ethernet communications is provided. One welding system includes a power supply configured to generate power for welding. The power supply includes a first processing circuit for implementing a predetermined welding regime and a first Ethernet interface coupled to the first processing circuit and configured to communicate via an Ethernet protocol. The system also includes a wire feeder coupled to the power supply to receive the power from the power supply and to provide welding wire for welding. The wire feeder includes a second processing circuit for controlling operation of the wire feeder and a second Ethernet interface coupled to the second processing circuit and configured to communicate via an Ethernet protocol. The welding power supply and the wire feeder exchange welding parameter data in accordance with the Ethernet protocol via an Ethernet media cable coupled between the Ethernet interfaces.

### CROSS REFERENCE TO RELATED APPLICATIONS

This application is a Non-Provisional Patent Application of U.S. Provisional Patent Application No. 61/320,977 entitled “Use of Fast Ethernet as System Interconnect/Communications For Welding System”, filed Apr. 5, 2010, which is herein incorporated by reference.

### BACKGROUND

The invention relates generally to welding systems and, more particularly, to a welding system and method utilizing internal Ethernet communications.

Welding is a process that has become increasingly ubiquitous in various industries and applications. While such processes may be automated in certain contexts, a large number of applications continue to exist for manual welding operations. Such welding operations rely on a variety of types of equipment to ensure the supply of welding consumables (e.g., wire feed, shielding gas, etc.) is provided to the weld in an appropriate amount at the desired time. For example, metal inert gas (MIG) welding typically relies on a wire feeder to ensure a proper wire feed reaches a welding torch.

Welding power sources are utilized to provide power for such applications while wire feeders are used to deliver welding wire to a welding torch. Data cables enable welding power sources, wire feeders, and other welding equipment to communicate with each other. Historically, analog signals have been used to communicate data between welding equipment. However, some systems use digital signals to communicate data within a welding system, such as an EIA/RS-485 based transmission. Unfortunately, with such systems the bandwidth may be narrowly limited, the protocols may be difficult to work with, the infrastructure may be proprietary, and there may not be inherent electrical isolation. Accordingly, there exists a need for data communication systems between welding equipment that overcome such disadvantages.

### BRIEF DESCRIPTION

In an exemplary embodiment, a welding system includes a welding power supply configured to generate welding power for a welding application. The welding power supply includes a first processing circuit for implementing a predetermined welding regime and a first Ethernet interface coupled to the first processing circuit. The first media access controller is configured to communicate via an Ethernet protocol. The welding system also includes a wire feeder coupled to the power supply to receive the welding power from the power supply and to provide welding wire to the welding application. The wire feeder includes a second processing circuit for controlling operation of the wire feeder and a second Ethernet interface coupled to the second processing circuit. The second media access controller is configured to communicate via an Ethernet protocol. The welding power supply and the wire feeder exchange welding parameter data in accordance with the Ethernet protocol via an Ethernet media cable coupled between the Ethernet interfaces.

In another embodiment, a method for welding includes receiving welding parameter data from a welding power supply including a first Ethernet interface in accordance with the Ethernet protocol via an Ethernet media cable coupled between the first Ethernet interface and a second Ethernet interface. The welding power supply is configured to generate welding power for a welding application. A welding device includes the second Ethernet interface. The method for welding also includes receiving power from the welding power supply via the Ethernet media cable for operation of the welding device when a welding operation is not ongoing. The method includes energizing the welding device via the power from the welding power supply transmitting welding parameter data from the welding device to the welding power supply in accordance with the Ethernet protocol via the Ethernet media cable.

In another embodiment, a welding power supply includes a processing circuit for implementing a predetermine welding regime and a Ethernet interface coupled to the processing circuit and configured to communicate via an Ethernet protocol. The power supply includes an Ethernet port coupled to the Ethernet interface and configured to exchange welding parameter data in accordance with the Ethernet protocol via an Ethernet media cable coupled between the Ethernet port and a welding device.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary welding system in accordance with aspects of the present invention;

FIG. 2 is a schematic diagram of an exemplary welding system utilizing internal Ethernet communications;

FIG. 2A is a schematic diagram of an exemplary welding system utilizing internal wireless Ethernet communications;

FIG. 3 is a schematic diagram of another exemplary welding system utilizing internal Ethernet communications;

FIG. 4 is a schematic diagram of another exemplary welding system utilizing internal Ethernet communications;

FIG. 4A is a schematic diagram of another exemplary welding system utilizing internal wireless Ethernet communications; and

FIG. 5 is a flow chart of an exemplary welding method utilizing internal Ethernet communications.

### DETAILED DESCRIPTION

As described in detail below, embodiments of systems utilizing internal Ethernet communications are provided. It should be noted that prior publications have disclosed using Ethernet communication with a welder, such as between a computer network and a welder, or between the internet and a welder. For examples see Houston et al., U.S. Publication Number 2004/0065650 and Blankenship et al., U.S. Publication Number 2005/0258154. However, the present disclosure pertains to Ethernet communications within a welding system, such as between a welding power supply and a wire feeder. Such a system may increase the operating bandwidth, provide interoperability with existing protocols, use industry standard infrastructure, and provide inherent electrical isolation. For example, the bandwidth of communication between welding equipment may increase to approximately 10, 100, or 1000 Megabits per second. In one embodiment, a welding system includes a welding power supply with a media access controller coupled to a processing circuit. The welding system also includes a wire feeder with a media access controller coupled to a processing circuit. The media access controllers are configured to communicate via an Ethernet protocol. The welding power supply and the wire feeder exchange welding parameter data in accordance with the Ethernet protocol via an Ethernet media cable coupled between the media access controllers.

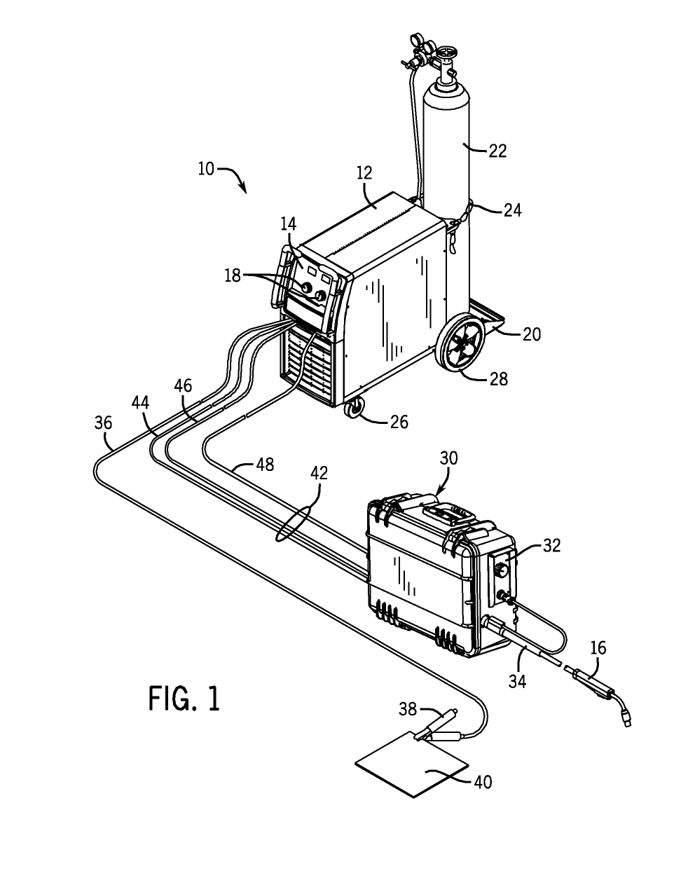

Turning now to the figures, FIG. 1 illustrates an exemplary welding system 10 which powers, controls, and provides supplies to a welding operation. The welding system 10 includes a welding power supply 12 having a control panel 14 through which a welding operator may control the supply of welding materials, such as gas flow, wire feed, and so forth, to a welding gun 16. To that end, the control panel 14 includes input or interface devices, such as knobs 18 that the operator may use to adjust welding parameters (e.g., voltage, current, etc.). The welding power supply 12 may also include a tray 20 mounted on a back of the power supply 12 and configured to support a gas cylinder 22 held in place with a chain 24. The gas cylinder 22 is the source of the gas that supplies the welding gun 16. Furthermore, the welding power supply 12 may be portable via a set of smaller front wheels 26 and a set of larger back wheels 28, which enable the operator to move the power supply 12 to the location of the weld.

The welding system 10 also includes a wire feeder 30 that provides welding wire to the welding gun 16 for use in the welding operation. The wire feeder 30 may include a control panel 32 that allows the user to set one or more wire feed parameters, such as wire feed speed. Additionally, the wire feeder 30 may house a variety of internal components, such as a wire spool, a wire feed drive system, a motor, and so forth. Additionally, the wire feeder 30 may be used with any wire feeding process, such as gas operations (gas metal arc welding (GMAW)) or gasless operations (shielded metal arc welding (SMAW)). For example, the wire feeder may be used in metal inert gas (MIG) welding or stick welding.

A variety of cables couple the components of the welding system 10 together and facilitate the supply of welding materials to the welding gun 16. A first cable 34 couples the welding gun 16 to the wire feeder 30. A second cable 36 couples the welding power supply 12 to a work clamp 38 that connects to a workpiece 40 to complete the circuit between the welding power supply 12 and the welding gun 16 during a welding operation. A bundle 42 of cables couples the welding power supply 12 to the wire feeder 30 and provides weld materials for use in the welding operation. The bundle 42 includes a welding power lead 44, a gas hose 46, and a control cable 48. The control cable 48 may be an Ethernet control cable including power over Ethernet, a combination of an Ethernet control cable and an auxiliary power cable, another type of control cable including auxiliary power, or an auxiliary power cable. Depending on the polarity of the welding process, the terminal connections for the welding power lead 44 and cable 36 may be swapped. It should be noted that the bundle 42 of cables may not be bundled together in some embodiments.

It should be noted that modifications to the exemplary welding system 10 of FIG. 1 may be made in accordance with aspects of the present invention. For example, the tray 20 may be eliminated from the welder 12 and the gas cylinder 22 may be located on an auxiliary support cart or in a location remote from the welding operation. Furthermore, although the illustrated embodiments are described in the context of a constant voltage MIG welding process, the features of the invention may be utilized with a variety of other suitable welding systems and processes.

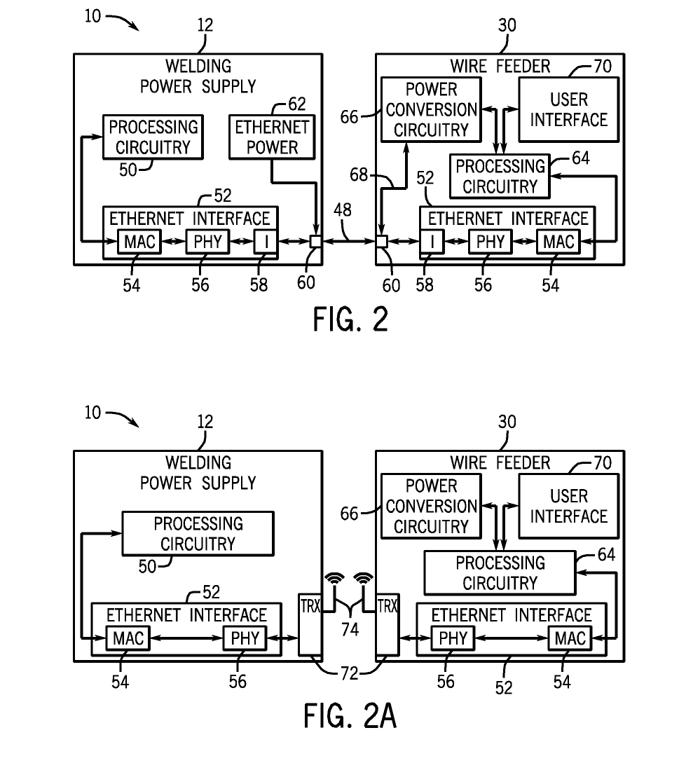

FIG. 2 is a schematic diagram of an exemplary welding system 10 utilizing internal Ethernet communications. The welding power supply 12 and the wire feeder 30 are depicted with the control cable 48 connected between the two devices. The control cable 48 is an Ethernet control cable including power over Ethernet. However, in certain embodiments, the interface cable 48 does not include power over Ethernet. The welding power supply 12 includes processing circuitry 50. The processing circuitry 50 sends and receives signals for controlling welding operations, such as for implementing a predetermined welding regime. Further, the processing circuitry 50 may include a microprocessor. The processing circuitry 50 communicates with an Ethernet interface 52. As illustrated, the Ethernet interface 52 may be a standalone device. However, in certain embodiments, the Ethernet interface 52 may be included on another device separate from the processing circuitry 50, or at least part of the Ethernet interface 52 may be included within the processing circuitry 50. The Ethernet interface 52 enables the welding power supply 12 to communicate over a welding network. Within the welding network, welding equipment communicates using an Ethernet protocol. Furthermore, the Ethernet interface 52 may enable devices to connect to each other using cables or wirelessly.

A media access controller 54, an Ethernet physical transceiver 56, and an isolation device 58 are part of the Ethernet interface 52. The media access controller 54 implements the media access control data communication protocol sub-layer of the data link layer and provides the physical address or MAC address of the Ethernet interface 52, thus enabling communication via the Ethernet protocol. The Ethernet physical transceiver 56 communicates with the media access controller 54 using an interface, such as MR, RMII, or any other interface, including proprietary interfaces. The isolation device 58 is connected to the Ethernet physical transceiver 56 to provide electrical isolation between the Ethernet interface 52 and an external connection, such as through a port 60. The isolation device 58 may be a transformer, an optical isolator, or another device that provides electrical isolation. The port 60 may be any type of port, such as Ethernet (RJ45), fiber optics, and so forth. Further, an Ethernet power 62 may be provided to port 60 to enable power through control cable 48 in addition to Ethernet communication. It should be noted that certain embodiments may not use the Ethernet physical transceiver 56 and thus operate by direct media access controller to media access controller communication.

The wire feeder 30 includes a processing circuitry 64 which controls operation of the wire feeder. The processing circuitry 64 communicates with the Ethernet interface 52, which is coupled to port 60. In addition to data, power may also be transmitted over the control cable 48. The power may come from the welding power supply 12 and be received by a power conversion circuitry 66 of the wire feeder 30 via connection 68. The power conversion circuitry 66 may convert the power over Ethernet for use in the wire feeder 30, such as to provide wake-up power when a welding operation starts. The power conversion circuitry 66 provides power to the processing circuitry 64. The processing circuitry 64 may receive input from a user interface 70 through which a user may input desired parameters (e.g., voltages, currents, wire speed, and so forth).

In such a system, the welding power supply 12 communicates with the wire feeder 30 using the Ethernet protocol to transport data over the control cable 48. Furthermore, as discussed, power and data may be transmitted over the cable 48 to provide power to control circuitry of welding equipment, such as to a microprocessor. Because the welding power supply 12 is connected directly to the wire feeder 30, the control cable 48 may be configured as a crossover cable, thus enabling the direct communication.

FIG. 2A is a schematic diagram of an exemplary welding system 10 utilizing internal wireless Ethernet communications. As illustrated, the Ethernet interfaces 52 of the welding power supply 12 and the wire feeder 30 each include the media access controller 54 and the Ethernet physical transceiver 56. Further, the Ethernet interfaces 52 of the welding power supply 12 and the wire feeder 30 are each connected to a transceiver 72 with an antenna 74 to enable wireless communication between the devices. The transceiver 72 may be configured to communicate using industry standards such as Wi-Fi. As such, the welding power supply 12 and the wire feeder 30 can communicate over an internal network without an Ethernet cable connection between the devices.

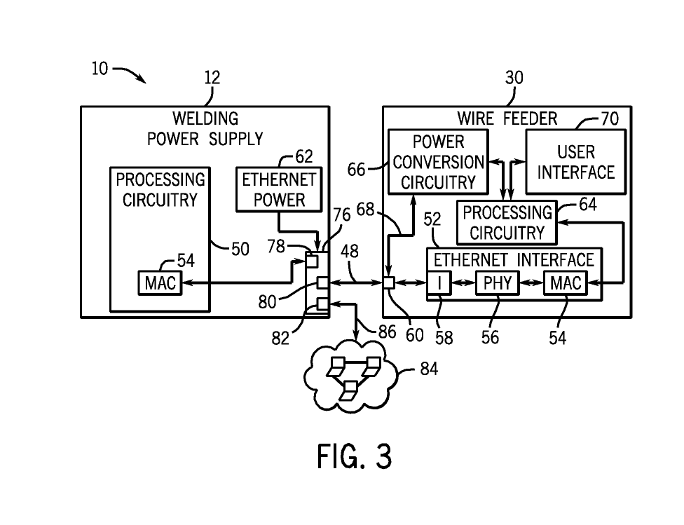

FIG. 3 is a schematic diagram of another exemplary welding system 10 utilizing internal Ethernet communications. The processing circuitry 50 of the welding power supply 12 includes the media access controller 54. For example, a microprocessor within processing circuitry 50 may include the media access controller 54. The welding power supply 12 includes a network switch 76 with ports 78, 80, and 82. However, switches with any number of ports may be used in other embodiments. Further, the network switch 76 may enable direct connection between a port of the switch and a media access controller external to the switch. For example, some network switch ports may include a media access controller without an Ethernet physical transceiver to enable such a direct media access controller connection. However, in other embodiments, network switch ports may include a media access controller and an Ethernet physical transceiver, thus connecting externally to another Ethernet physical transceiver. As depicted, port 78 is an internal port configured for connecting directly to the media access controller 54. A computer network 84 is connected to port 82 using Ethernet cable 86. To communicate with the computer network 84, the Ethernet cable 86 may be a crossover cable. The welding power supply 12 may send to and/or receive data from the computer network 84 to enable the welding power supply 12 to be monitored or controlled remotely. The Ethernet power 62 connects to the switch 76 to enable power over Ethernet. The wire feeder 30 is connected to port 80 of the switch 76 using the control cable 48.

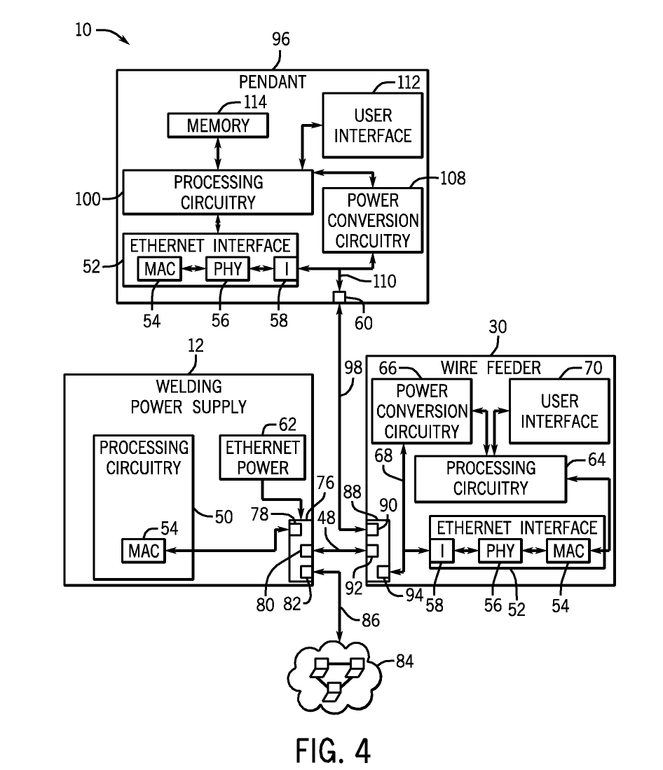

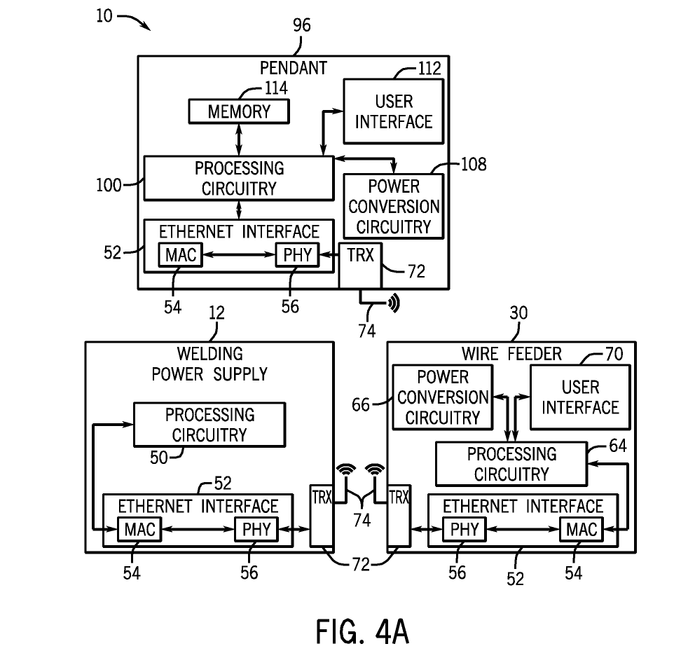

FIG. 4 is a schematic diagram of another exemplary welding system 10 utilizing internal Ethernet communications. The welding power supply 12 includes the processing circuitry 50 that further includes the media access controller 54. The power supply 12 also includes the switch 76 with ports 78, 80, and 82. The media access controller 54 of the welding power supply 12 is connected to port 78 of the switch 76. Again, the computer network 84 is connected to port 82 via cable 86.

The wire feeder 30 includes the Ethernet interface 52 separate from the processing circuitry 64. The wire feeder 30 also includes a switch 88 with three ports 90, 92, and 94. However, other embodiments may have switches with any number of ports. The Ethernet interface 52 and the power conversion circuitry 66 of the wire feeder 30 connect to the internal port 94 of the switch 88. The control cable 48 connects between port 80 on switch 76 of the welding power supply 12 and port 92 on switch 88 of the wire feeder 30. The control cable 48 may be a crossover cable to connect the two switches 76 and 88 together.

A pendant 96 connects to port 90 of switch 88 of the wire feeder 30 using cable 98. The pendant 96 includes processing circuitry 100 which controls the operations of the pendant. The processing circuitry 100 is connected to Ethernet interface 52. The Ethernet interface 52 connects to port 60 of the pendant 96. Likewise, the cable 98 also connects to port 60, thus enabling data and/or power to be accessible to the pendant 96. The pendant 96 includes a power conversion circuitry 108 which may receive power over Ethernet via connection 110. The power conversion circuitry 108 converts the power from Ethernet cable 98 to power that may be provided to the processing circuitry 100. The processing circuitry 100 may receive input from a user interface 112 through which a user may input desired parameters (e.g., voltages, currents, and so forth). The processing circuitry 100 may also store data and instructions in a memory 114. By receiving power over Ethernet, the pendant 96 may be powered, such as for a wake-up routine or for other power applications, and may decrease the time needed to start a welding operation.

FIG. 4A is a schematic diagram of another exemplary welding system 10 utilizing internal wireless Ethernet communications. As illustrated, the Ethernet interfaces 52 of the welding power supply 12, the wire feeder 30, and the pendant 96 each include the media access controller 54 and the Ethernet physical transceiver 56. Further, the Ethernet interfaces 52 of the welding power supply 12, the wire feeder 30, and the pendant 96 are each connected to a transceiver 72 with an antenna 74 to enable wireless communication between the devices. As previously discussed, the transceiver 72 may be configured to communicate using industry standards such as Wi-Fi. As such, the welding power supply 12, the wire feeder 30, and the pendant 96 can communicate over an internal network without an Ethernet cable connection between the devices.

It should be noted that there are many possible variations of the embodiments disclosed in FIGS. 2 through 4. For example, zero, one or more of the welding power supply 12, wire feeder 30, and pendant 96 may include a network switch or wireless transceiver. The pendant 96 may be connected to either the wire feeder 30, or the welding power supply 12. Furthermore, the computer network 84 may not be included in the welding network. The media access controllers, the Ethernet physical transceivers, the isolation devices, and/or the Ethernet interfaces may be separate from or a part of the processing circuitry for any particular welding device. In addition, the term “Ethernet interface” may be used to refer to a media access controller, Ethernet physical transceiver, and isolation device, individually, collectively, or with any combination thereof.

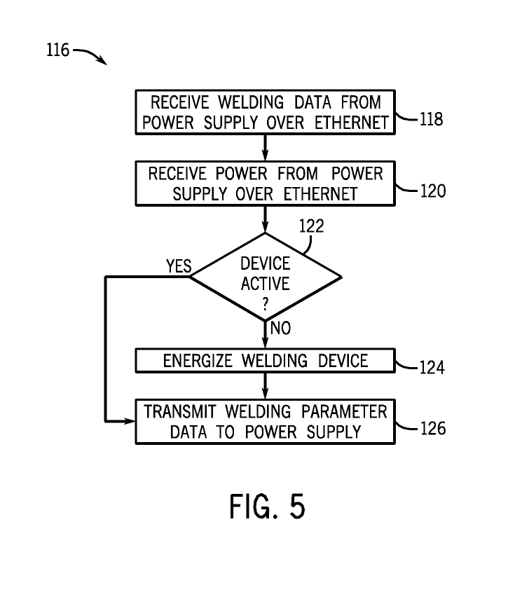

FIG. 5 is a flow chart of an exemplary welding method 116 utilizing internal Ethernet communications. At step 118, welding device receives welding data from a welding power supply via an Ethernet cable. Then, at step 120, the welding device receives power from the welding power supply via the Ethernet cable for operation of the welding device when a welding operation is not ongoing. Next, at step 122, a determination is made as to whether the welding device is active. If the welding device is not active, at step 124 the welding device is energized via the power from the welding power supply. If the welding device is active, step 124 is skipped and step 126 is performed. At step 126, welding parameter data is transmitted from the welding device to the welding power supply using the Ethernet protocol via the Ethernet cable.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system comprising:
a welding power supply configured to generate welding power for a welding application, the welding power supply comprising a first processing circuit for implementing a predetermined welding regime and a first Ethernet interface coupled to the first processing circuit and configured to communicate via an Ethernet protocol; and
a wire feeder coupled to the power supply to receive the welding power from the power supply and to provide welding wire to the welding application, the wire feeder comprising a second processing circuit for controlling operation of the wire feeder and a second Ethernet interface coupled to the second processing circuit and configured to communicate via an Ethernet protocol;
wherein the welding power supply and the wire feeder exchange welding parameter data in accordance with the Ethernet protocol via an Ethernet media cable coupled between the Ethernet interfaces.

2. The system of claim 1, wherein the wire feeder receives power from the welding power supply via the Ethernet media cable for operation of the wire feeder when a welding operation is not ongoing.

3. The system of claim 1, comprising a pendant coupled to the wire feeder to receive power from the wire feeder and to provide control signals to the welding application, the pendant comprising a third processing circuit for controlling operation of the pendant and a third Ethernet interface coupled to the third processing circuit and configured to communicate via an Ethernet protocol.

4. The system of claim 1, comprising a pendant coupled to the power supply to receive power from the power supply and to provide control signals to the welding application, the pendant comprising a third processing circuit for controlling operation of the pendant and a third Ethernet interface coupled to the third processing circuit and configured to communicate via an Ethernet protocol.

5. The system of claim 4, wherein the pendant receives power from the welding power supply via the Ethernet media cable for operation of the pendant when a welding operation is not ongoing.

6. The system of claim 1, wherein at least one of the first Ethernet interface is internal to the first processing circuitry and the second Ethernet interface is internal to the second processing circuitry.

7. The system of claim 1, wherein at least one of the first Ethernet interface is external to the first processing circuitry and the second Ethernet interface is external to the second processing circuitry.

8. The system of claim 1, comprising a first switch coupled between the first Ethernet interface, the second Ethernet interface, and at least one additional component of the welding system comprising a third Ethernet interface.

9. The system of claim 1, comprising a first switch coupled between the first Ethernet interface and a second switch, the second switch coupled between the first switch, the second Ethernet interface, and at least one additional component of the welding system comprising a third Ethernet interface.

10. The system of claim 1, comprising a first transceiver coupled to the first Ethernet interface and a second transceiver coupled to the second Ethernet interface to enable the Ethernet interfaces to communicate wirelessly.

11. A method for welding comprising:
receiving welding parameter data from a welding power supply comprising a first Ethernet interface in accordance with the Ethernet protocol via an Ethernet media cable coupled between the first Ethernet interface and a second Ethernet interface, the welding power supply configured to generate welding power for a welding application, a welding device comprising the second Ethernet interface;
receiving power from the welding power supply via the Ethernet media cable for operation of the welding device when a welding operation is not ongoing;
energizing the welding device via the power from the welding power supply; and
transmitting welding parameter data from the welding device to the welding power supply in accordance with the Ethernet protocol via the Ethernet media cable.

12. The method of claim 11, wherein the welding device comprises a wire feeder.

13. The method of claim 11, wherein the welding device comprises a pendant.

14. The method of claim 11, wherein the welding power supply comprises a first processing circuit for implementing a predetermined welding regime and the welding device comprises a second processing circuit for controlling operation of the welding device.

15. The method of claim 14, wherein the first processing circuit comprises the first Ethernet interface and the second processing circuit comprises the second Ethernet interface.

16. A welding power supply comprising:
a processing circuit for implementing a predetermine welding regime;
a Ethernet interface coupled to the processing circuit and configured to communicate via an Ethernet protocol; and
an Ethernet port coupled to the Ethernet interface and configured to exchange welding parameter data in accordance with the Ethernet protocol via an Ethernet media cable coupled between the Ethernet port and a welding device.

17. The power supply of claim 16, wherein the welding device is a wire feeder.

18. The power supply of claim 16, wherein the welding device is a pendant.

19. The power supply of claim 16, comprising a switch coupled to the Ethernet port and configured to couple one or more welding devices to the power supply.

20. The power supply of claim 16, wherein the Ethernet port is configured to send power to the welding device via an Ethernet cable.
